(19) United States
(12) Patent Application Publication
(10) Pub. No.: US 2015/0184025 A1
(43) Pub. Date: Jul. 2, 2015

(54) Biomass Bio Oil Upgrade Method

(71) Applicant: Mahesh Talwar, Somis, CA (US)

(72) Inventor: Mahesh Talwar, Somis, CA (US)

(21) Appl. No.: 14/140,956

(22) Filed: Dec. 26, 2013

Related U.S. Application Data
(63) Continuation-in-part of application No. 14/140,766, filed on Dec. 26, 2013.

(51) Int. Cl. C09D 195/00; C09D 191/00; C08L 95/00

(52) U.S. Cl. CPC C09D 195/00; C08L 95/00; C09D 191/00; C08L 2555/80

(57) ABSTRACT

A bio oil pyrolysis and conditioning system produces a useful road asphalt. The pyrolysis system includes an auger carrying biomass feed material though an oxygen rare pyrolysis chamber. Vapor phase bio oil is collected at three locations along the length of the pyrolysis chamber and carried from the pyrolysis chamber to condensers and quenched by a water spray before release into the condensers. The water also serving as a solvent to reduce pH in the liquid phase raw bio oil. The raw bio oil is carried to a conditioning system where the raw bio oil resides in a separation tank where the water separates and is removed producing refined bio oil. The refined bio oil is mixed with an equal or greater amount of petroleum asphalt to obtain a substitute for road asphalt.

The present application is a Continuation In Part of U.S. patent application Ser. No. 14/140,766 filed Dec. 26, 2013, which application is incorporated in its entirety herein by reference.

### BACKGROUND OF THE INVENTION

The present invention relates to biomass bio oil and in particular to a method for converting biomass feed material into a useful road asphalt.

Biomass is comprised mainly of cellulose, hemi cellulose and lignin. A typical woody biomass may contain 40-50% cellulose, 25-35% hemi cellulose, and 15-18% lignin. Typical yields from a slow pyrolysis machine are 30% charcoal containing 70% plus carbon, 35% non-condensable gases containing hydrogen, methane, carbon mono oxide, carbon dioxide primarily, and 35% pyrolysis oil, also known as bio oil or bio crude, consisting tar, aldehydes, formic acid, acetic acid, water, esters, phenols, sugar derivatives, lignins. Such typical slow pyrolysis machine yields oil and charcoal in nearly equal portions. Slow pyrolysis involves heating of dried biomass (<8% moisture) in an oxygen free environment at 450-500 degrees centigrade in heated auger tubes. The process involves thermo chemical conversion of solid biomass to a liquid product, bio oil, and solid material, charcoal. Non condensable gases are utilized to heat the incoming wet biomass material, thus creating a closed loop system.

Convention slow pyrolysis process yields bio oil that has the following properties:

CH_{1.3}O_{0.47} Chemical formula

Flash point: 80 deg C

pH=2.5

Sp Gr.=1.2

Moisture content: 20-25%

Heating value=7,522 btu/lb (17.5 mj/kg)

Viscosity=60-100 cp

and

### Elemental Analysis:

C=55-60%

H=5-8%

O=28-40%

N=0.06%

Unfortunately, there are several issues with the use of such bio oil as a heating oil. The bio oil has a very low pH. Formation of acetic acid and formic acid during the pyrolysis process (derived mainly from the hemi cellulose portion of the wood) are the cause of low and highly acidic pH which makes it difficult to use this fuel with carbon steel, aluminum and natural rubber due to corrosion issues. To avoid corrosion issues, pH of the fuel should be close to neutral 7. The viscosity of bio oil can be as high as 100 cp and as a result can cause issues with the spray nozzles, fuel pumps, and other fuel handling equipment. Very heavy fuel oil such as Bunker C can have very high viscosity, however, upon heating; the viscosity of heavy petroleum fuels goes down to acceptable levels. Heating of bio oil leads to polymerization and hardening of fuel, thus making the problem worse. Additionally, the bio oil is immiscible with all petroleum fuels, so it cannot be mixed with other low viscosity fuel oils to lower its viscosity either. Over time, the bio oil starts to degrade due to the polymerization reactions. It becomes more viscous and water starts to separate out. This phenomenon can happen in as little as 30 days. Viscosity can increase tenfold at times. Heating value of bio oil is approximately 45% of that of fuel oil due to the presence of high levels of oxygen and water.

Other attempted uses of bio oil include utilization as a substitute for road asphalt, also known as hot mix asphalt. Asphalt is currently derived from petroleum sources. Road asphalt may contain certain additives to prevent cracking, providing elasticity, and increased weather resistance. Raw bio oil, when heated, would indeed polymerize and harden; however, it still does not harden enough for use as road asphalt. Asphalt application for road requires that the asphalt harden within 24 hours to resume traffic, bio oil's utilization as asphalt does not contain this quick hardening property

### BRIEF SUMMARY OF THE INVENTION

The present invention addresses the above and other needs by providing a bio oil pyrolysis and conditioning system which produces a useful road asphalt. The pyrolysis system includes an auger carrying biomass feed material though an oxygen rare pyrolysis chamber. Vapor phase bio oil is collected at three locations along the length of the pyrolysis chamber and carried from the pyrolysis chamber to condensers and quenched by a water spray before release into the condensers. The water also serving as a solvent to reduce pH in the liquid phase raw bio oil. The raw bio oil is carried to a conditioning system where the raw bio oil resides in a separation tank where the water separates and is removed producing refined bio oil. The refined bio oil is mixed with an equal or greater amount of petroleum asphalt to obtain a substitute for road asphalt.

In accordance with one aspect of the invention, there is provided a pyrolysis system including quenching of bio oil in vapor phase. Longer residence times of vapors from a pyrolysis chamber in the presence of charcoal tend to increase tar formation. To reduce such tar formation, vapors coming from the pyrolysis chamber are quickly quenched by a spray of cooling water. Other oils, for example, bio diesel or the pyrolysis oil itself, may be used as a cooling medium, however, the use of water is beneficial for the following step explained below. Reduction in tar formation helps keep the viscosity of the bio oil lower and prevents clogging of the lines and equipment from tar formation.

In accordance with another aspect of the invention, bio oil pH is reduced by removing water soluble formic and acetic acids from the bio oil using water as a solvent. Experiments with varying amounts of water found that water addition in the amount of 40-50 percent in the liquid phase bio oil by volume results in the formation of two district phases, an aqueous phase and an oil phase, with the aqueous phase floating to the top. Additionally, the aqueous phase pulls the water soluble acidic constituents of raw bio oil resulting in a refined bio oil. The aqueous phase is drained providing the refined bio oil for further processing. The pH of the aqueous phase is generally about 2.5, while the pH of the refined bio oil is generally about 6.2. The water added during the quenching process thus provides two advantages: a) better contact of water and oil and b) a cooling medium at the same time.

In accordance with yet another aspect of the invention, the bio oil is mixed with at least 20% ethanol (i.e., one part bio oil and at least 0.2 parts ethanol) and preferably the bio oil is mixed with at about 20% ethanol. Bio oil is soluble in ethanol. Viscosity of bio oil obtained from mixing of ethanol is reduced to 4-5 cp which makes it very comparable to that of fuel oil. The bio oil can now be used as fuel without heating. Methanol may be used, but ethanol is renewable and has a higher heating value of compared to methanol. Additionally, stability of bio oil was enhanced with the addition of ethanol. Ethanol also has a higher flash point compared to methanol and is therefore easier and safer to handle. Due to the solvent nature of ethanol, no water separation has been observed and the bio oil remains in homogeneous phase with no increase in viscosity for the observation period of six months. Additional of ethanol also helps as an ignition improver. Ethanol also helps improve clogging in lines and keeps the storage and contact surfaces clean.

In accordance with still another aspect of the invention, the heating value of the bio oil is increased from 17.5 kj/kg to 22.5-25 kj/kg, thus making the bio oil closer to petroleum fuel oils and a viable fuel.

In accordance with another aspect of the invention, a combination of quench, water extraction, ethanol addition resulted in fuel that has higher pH, more stable, extremely low viscosity, stable and useable as a heating fuel (closer to #4 fuel oil) without needing any external heating. The heating value of bio oil unexpectedly increased about 25%, providing a commercial viability bio oil.

In accordance with yet another aspect of the invention, there is provided a substitute for road asphalt, also known as hot mix asphalt. Currently, asphalt is derived from petroleum sources. Road asphalt may contain certain additives to prevent cracking, providing elasticity, and increased weather resistance. There are several issues with the use of Raw Bio Oil: Raw bio oil when heated would indeed polymerize and harden; however, it still does not harden enough for use as road asphalt. Asphalt application for road also require that the asphalt harden within 24 hours to resume traffic, bio oil's utilization as asphalt does not contain this quick hardening property. The substitute for road asphalt is obtained using refined bio oil, which is essentially devoid of acidic components to reduce pH, mixed with an equal or greater amount of petroleum asphalt. Such a mixture unexpectedly hardens and behaves like a standard asphalt. Greater amounts of petroleum asphalt may be used if desired. A secondary benefit is that using of raw bio oil as a road asphalt ingredient also imparted a shiny glow to the surface which improves appearance.

In accordance with another aspect of the invention, there is provided a method for processing bio mass. The method includes feeding biomass material into an oxygen rare pyrolysis chamber, heating the biomass material to create vapor phase bio oil, carrying vapor phase bio oil from the pyrolysis chamber to a condenser, quenching the vapor phase bio oil before releasing into the condenser, cooling the vapor phase bio oil in the condenser, condensing the vapor phase bio oil into liquid phase raw bio oil in the condenser, separating water from the raw bio oil to produce refined bio oil, and mixing petroleum asphalt with the refined bio oil to produce a substitute for road asphalt.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a pyrolysis system for producing bio oil according to the present invention.

FIG. 2 is a bio oil conditioning system according to the present invention.

FIG. 3 is a method according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

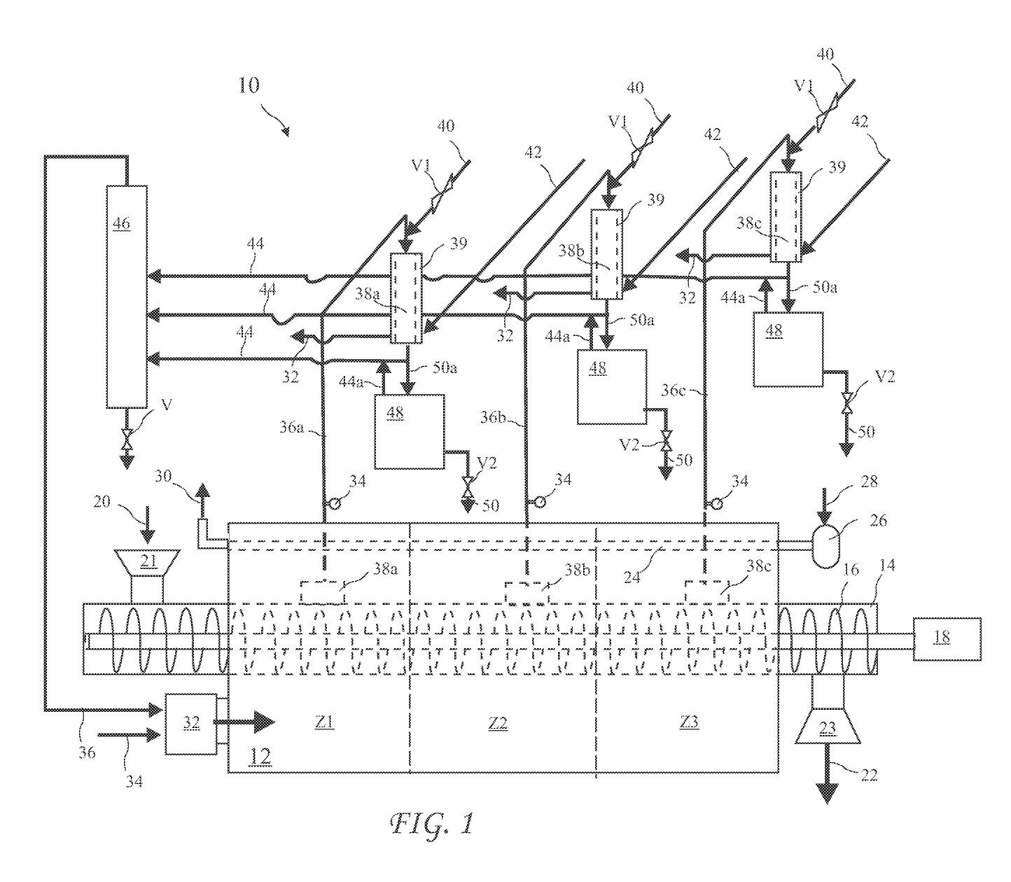

A pyrolysis system 10 for producing bio oil according to the present invention is shown in FIG. 1. The pyrolysis system 10 primarily includes a pyrolysis chamber 12 and condensers 38a, 38b, and 38c. An auger 16 residing in an auger housing 14 extends through the length of the pyrolysis chamber 12 and is rotated by a motor 18. Biomass feed material 20, for example dry sawdust, is fed through an entry 21 into the auger housing 14 at one end of the pyrolysis chamber 12 and charcoal material 22 is released from the auger housing 14 through a chute 23 at an opposite end of the pyrolysis chamber 12. The interior of the pyrolysis chamber 12 is substantially oxygen free and at a high temperature, causing the biomass feed material 20 to release vapors phase bio oil into the interior of the pyrolysis chamber 12. A hot air tube 24 runs through the pyrolysis chamber 12 above the auger housing 14 carrying ambient air 28 heated and pumped by heater 26 and released on the opposite end of the pyrolysis chamber 12. The exhaust 30 from the hot air tube 24 is directed to dry incoming biomass material 20.

The vapor phase bio oil generated in the pyrolysis chamber 12 is collected in the collectors 38a, 38b, and 38c and vapor flows 36a, 36b, and 36c respectively are carried to double wall condensers 38. The collectors 38a, 38b, and 38c receive the vapor phase bio oil from three zones of the pyrolysis chamber 12. A first zone, zone Z1, is approximately the first third of the pyrolysis chamber 12 length which will allow the collection of mostly moisture vaporized along with some very light ends. A second zone, zone Z2, is approximately the second third of the pyrolysis chamber 12 length to collect light vapors and acid constituents vapors along with the reaction water. A third zone, zone Z3, is approximately the last third of the pyrolysis chamber 12 length to collect heavier vapors, for example, vapor phase tar. The multiple collectors 38a, 38b, and 38c allow product segregation from light to heavy ends in addition to keeping the water content of light and heavy liquid products low. Additionally, the multiple collectors 38a, 38b, and 38c allow for heavy liquid to have pH closer to 6 rather than 2.5. The light liquid will have pH of 2.5 but the absence of tar in that allows lowering of pH by conventional means, such as addition of alkali.

Temperature indicators 34 monitor the temperature of the vapor flows 36. Quench water 40 is introduced into the vapor phase bio oil flows 36a, 36b, and 36c through valves V1 before the vapors enter the condensers 38a, 38b, and 38c, and cooling water 42 is provided between the double walls 39 of the condensers 38a, 38b, and 38c to cool the vapor phase bio oil flows 36a, 36b, and 36c passing through the centers of the double wall condensers 38a, 38b, and 38c, the cooling water 42 exits the condensers 38a, 38b, and 38c as flows 32. The amounts of quench water 40 is controlled to obtain desired properties of a liquid phase bio oil 50a and 50. Quench water 40 also acts as solvent to extract acidic components from the liquid phase bio oil 50a and 50 which makes the bio oil more transportable and stable.

The amounts of quench water 40 provided is preferably determined by the biomass feed material 20 feed rate into the pyrolysis chamber 12. The rate which the biomass feed material 20 is fed into the pyrolysis chamber 12 is monitored and an expected production of refined bio oil 86 is calculated. The refined bio oil 86 production is generally about 35 percent by weight of the biomass feed material 20. The rate of providing the quench water 40 is preferably controlled to result in a mixture 40 to 50 percent by volume of the quench water 40 and 50 to 60 percent by volume of bio oil in the raw bio oil 50.

Condensed bio oil 50a drains from the condensers 38a, 38b, and 38c into storage tanks 48. Condensed water 44 collected between the condensers 38a, 38b, and 38c and the storage tanks 48, and condensed water 44a from storage tanks 48, is carried to a water Knock Out (KO) drum 46. Raw bio oil 50a is released from the storage tanks 48 through second valves V2.

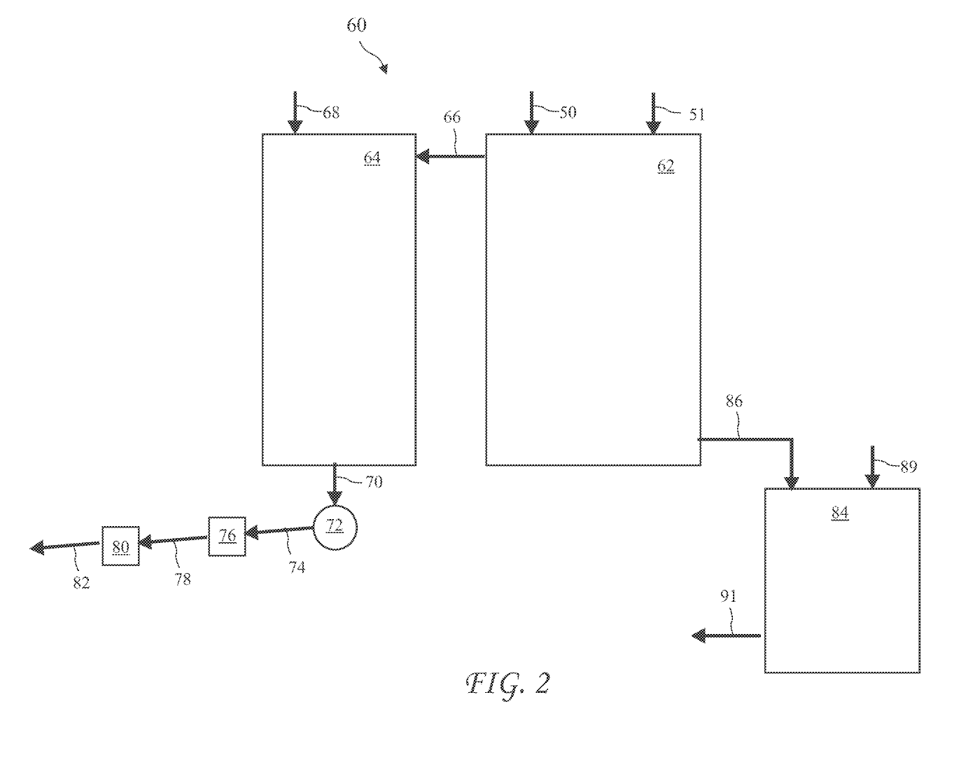

FIG. 2 is a bio oil fuel conditioning system 60 according to the present invention. The bio oil fuel conditioning system 60 includes an oil/water separator 62 which receives the raw bio oil 50 from the storage tanks 48 and separates water from the raw bio oil 50 to produce refined bio oil 86. The water 66 is transferred to a pH balance tank 64 which also receives a pH control additive 68 to produce pH balanced water, The pH balanced water 70. The pH balance water 70 is pumped by pump 72 from the pH balance tank 64 through a filter 76 to produces filtered water 78, and through a cooler 80 to produce cooled water 82, and to a cooled water supply. Optionally, additional water 51 may be added to the oil/water separator 62 if necessary as a solvent.

Separated refined bio oil 86 is carried to a mixing tank 84 where petroleum asphalt 89 is mixed with the refined bio oil 86 to create road asphalt 91. An amount of the petroleum asphalt 89 equal to or greater than the refined bio oil 86 by volume, is mixed with the refined bio oil 86 to produce the road asphalt 91.

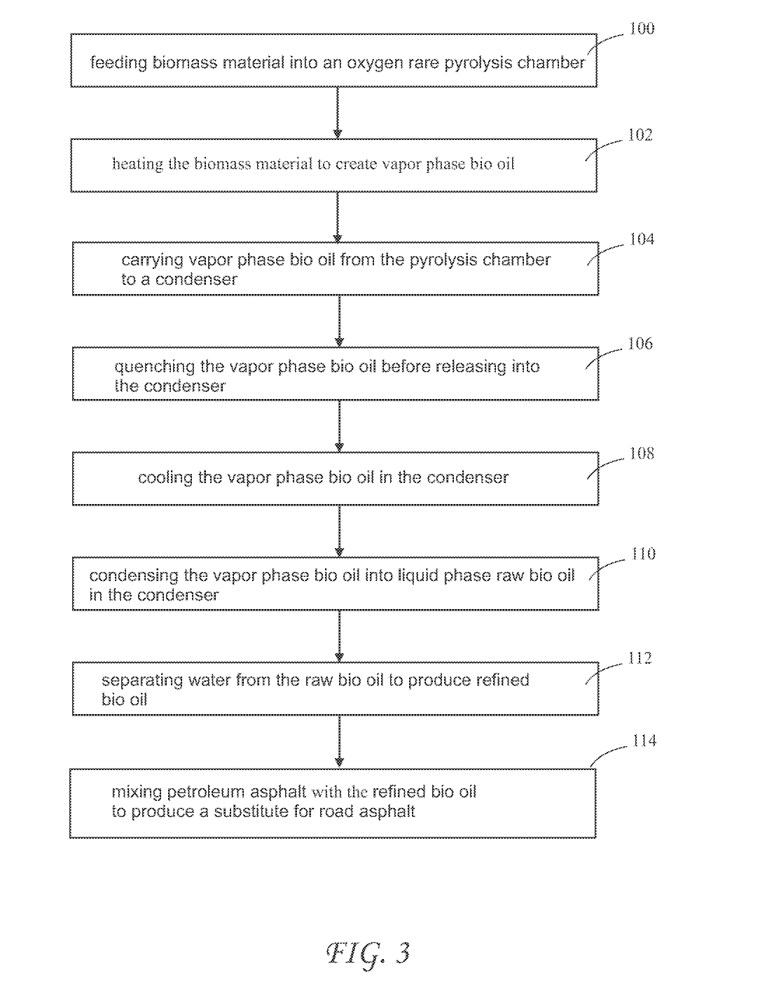

A method for processing biomass according to the present invention is shown in FIG. 3. The method includes feeding biomass material into an oxygen rare pyrolysis chamber at step 100, heating the biomass material to create vapor phase bio oil at step 102, carrying vapor phase bio oil from the pyrolysis chamber to a condenser at step 104, quenching the vapor phase bio oil before releasing into the condenser at step 106, cooling the vapor phase bio oil in the condenser at step 108, condensing the vapor phase bio oil into liquid phase raw bio oil in the condenser at step 110, separating water from the raw bio oil to produce refined bio oil at step 112, and mixing petroleum asphalt with the refined bio oil to produce a substitute for road asphalt at step 114.

While the invention herein disclosed has been described by means of specific embodiments and applications thereof, numerous modifications and variations could be made thereto by those skilled in the art without departing from the scope of the invention set forth in the claims.

I claim:

1. A method for producing road asphalt, the method comprising:
feeding biomass into a pyrolysis chamber;
heating the biomass to create vapor phase bio oil;
carrying the vapor phase bio oil to a condenser;
condensing the bio oil vapor into liquid phase raw bio oil in the condenser;
separating water from the raw bio oil in a separator to produce refined bio oil; and
processing the refined bio oil into a road asphalt.

2. The method of claim 1, further including quenching the vapor phase bio oil before releasing the vapor phase bio oil into the condenser.

3. The method of claim 2, wherein quenching comprises spraying water into the vapor phase bio oil before releasing the vapor phase bio oil into the condenser.

4. The method of claim 3, wherein spraying the water into the vapor phase bio oil comprises spraying the water into the vapor phase bio oil, resulting in the raw bio oil including 40 to 50 percent of the water by volume and 50 to 60 percent liquid phase bio oil by volume.

5. The method of claim 1, wherein:
the condenser is a double wall condenser; and
further including providing a coolant flow between the double walls of the condenser to cool the vapor phase bio oil flowing through the center of the condenser.

6. The method of claim 5, wherein providing a coolant flow between the double walls of the condenser comprises providing a flow of cool water between the double walls of the condenser

7. The method of claim 1, wherein processing the refined bio oil into a road asphalt comprises mixing at least an equal amount by volume of petroleum asphalt with the refined bio oil to produce the road asphalt.

8. The method of claim 1, wherein processing the refined bio oil into a road asphalt comprises mixing about an equal amount by volume of petroleum asphalt with the refined bio oil to produce the road asphalt.

9. The method of claim 1, wherein feeding biomass comprises feeding dry sawdust.

10. The method of claim 1, wherein feeding biomass into a pyrolysis chamber comprises feeding biomass into an oxygen rare pyrolysis chamber.

11. The method of claim 1, wherein;
the pyrolysis chamber comprises at least three zones:
a first zone nearest to the entry of the biomass feed material;
a second zone in the middle; and
a third zone opposite to the first zone;
and the method further including:
collecting vapor phase bio oil in collectors residing in each zone; and
carrying the collected vapor phase bio oil independently from each collector to corresponding condensers.

12. A method for producing road asphalt from biomass material, the method comprising:
feeding dry sawdust into an oxygen rare pyrolysis chamber;
heating the dry sawdust to create vapor phase bio oil;
carrying the vapor phase bio oil to a condenser;
quenching the vapor phase bio oil with water before releasing the vapor phase bio oil into the condenser;
condensing the bio oil vapor into liquid phase raw bio oil in the condenser;
carrying the liquid phase raw bio oil into a separation tank;
removing water from the liquid phase raw bio oil to produce refined bio oil in the separation tank;
carrying the refined bio oil from the separation tank into a mixing tank; and
mixed the refined bio oil with an equal or greater amount of petroleum asphalt by volume to produce the road asphalt.

13. A method for producing road asphalt from biomass material, the method comprising:
feeding biomass material into an oxygen rare pyrolysis chamber, the pyrolysis chamber comprises at least three zones:
a first zone nearest to the entry of the biomass feed material;
a second zone in the middle; and
a third zone opposite to the first zone;
heating the biomass material to create vapor phase bio oil;
collecting vapor phase bio oil in collectors residing in each zone; and
carrying the collected vapor phase bio oil independently from each collector to corresponding condensers;
quenching the vapor phase bio oil before releasing the vapor phase bio oil into the condensers, the quenching comprising spraying water into the vapor phase bio oil, resulting in liquid phase raw bio oil including 40 to 50 percent of the water by volume and 50 to 60 percent liquid phase bio oil by volume;
condensing the vapor phase bio oil into the liquid phase raw bio oil in the condensers;
releasing the liquid phase raw bio oil into a separation tank;
removing water from the liquid phase raw bio oil to produce refined bio oil;
carrying the refined bio oil into a mixing tank; and
mixed the refined bio oil with an equal or greater amount of petroleum asphalt by volume to produce the road asphalt.
